(19) United States
(12) Patent Application Publication
(10) Pub. No.: US 2023/0015765 A1
(43) Pub. Date: Jan. 19, 2023

(54) Vaporiser

(71) Applicant: JT International SA, Geneva (CH)

(72) Inventors: Kyle Adair, Lisburn (GB); Alec Wright, Guildford (GB); Andrew Robert John Rogan, Forres (GB)

(73) Assignee: JT International SA, Geneva (CH)

(21) Appl. No.: 17/786,856

(22) PCT Filed: Dec. 18, 2020
(86) PCT No.: PCT/EP2020/087306

§ 371 Date: Jun. 17, 2022

(30) Foreign Application Priority Data
Dec. 19, 2019 (EP) 19218295.4

(51) Int. Cl. A24F 40/46; G05D 3/12; A24F 40/10; A24F 40/44; A24F 40/60; A24F 40/51; A24B 15/167

(52) U.S. Cl. CPC A24F 40/46; A24B 15/167; A24F 40/10; A24F 40/44; A24F 40/51; A24F 40/60; G05D 3/12; H05B 3/20

(57) ABSTRACT

A vaporiser for an aerosol generating device comprises: a heating element including a sheet of heating material; a tubular heater housing arranged to hold the heating element within the heater housing; and a liquid store . The heater housing comprises a longitudinal gap running along the length of the tubular heater housing, and the heating element is arranged such that a peripheral edge of the heating element is supported within the gap. The gap is arranged to allow a liquid to pass from the liquid store into the heater housing to be vaporised by the heating element during use. The size of the gap is variable to change the rate of liquid flow through the gap , and, in particular, to maintain an optimum liquid flow rate despite a varying viscosity of the vaporisable liquid due to temperature or to differing types of vaporisable liquid being used.

The present invention relates to vaporiser for an aerosol generation device or system, such as an electronic cigarette.

### BACKGROUND

Known aerosol generation devices such as electronic cigarettes often use a heating component, or heater, to heat an aerosol generating liquid in order to generate an aerosol, or vapour, for inhalation by a user. The heating component is typically made of a conductive material which allows an electric current to flow through it when electrical energy is applied across the heating component. The electrical resistance of the conductive material causes heat to be generated as the electric current passes through the material, a process commonly known as resistive heating.

Heating components in the art include a metal wire or a fibre mesh array formed into different shapes, for example a coil wire. In use the heater is typically in contact or in close proximity to a wicking element that draws aerosol generating liquid from a reservoir or supply in the device to be vaporised. The wicking element commonly has a fibrous or porous structure which causes liquid to be drawn from the liquid supply by capillary action.

Some heating elements, in particular fibre mesh array heaters, combine the heating and wicking functions, where for example a sheet of electrically conductive porous material uses capillary action to draw the aerosol generating liquid from the reservoir into the heating component, which also provides heat when electrical energy is passed through it. The sheet of electrically conductive porous material can be shaped to optimise the synergy between heating and wicking functions.

There are several known problems with this kind of known device. In particular, capillary heaters do not always effectively transport the liquid from the liquid store for vaporisation. In particular, the geometry of the liquid transport route between the liquid store and the heating element must be carefully controlled to ensure that the right amount of liquid is delivered to the heating element - too little liquid and the heating element can overheat and possibly burn, too much and the heating element can be flooded causing a reduction in temperature and ineffective vaporisation. This problem is exacerbated by the fact that the viscosity of the liquid is an important parameter defining the rate of liquid flow to the heater and this can change between different types of vaporisable liquid and in response to changes in temperature.

An object of the invention is to provide a more reliable and effective vaporiser for an aerosol generation device.

### SUMMARY OF INVENTION

According the present invention there is provided a vaporiser for an aerosol generating device, the vaporiser comprising: a heating element comprising a sheet of heating material; a tubular heater housing arranged to hold the heating element within the heater housing; and a liquid store; wherein the heater housing comprises a longitudinal gap running along the length of the tubular heater housing and the heating element is arranged such that a peripheral edge of the heating element is supported within the gap; wherein the gap is arranged to allow a liquid pass from the liquid store into the heater housing to be vaporised by the heating element during use; and the size of the gap is variable to change the rate of liquid flow through the gap.

In this way, the rate of liquid flow between the liquid store and heating element can be adjusted to compensate for the effects of changing temperature or for different vaporisable liquids to optimise vapour generation. In particular, the size of the gap can be adjusted to maintain an optimum liquid flow rate despite a varying viscosity of the vaporisable liquid due to temperature or to differing types of vaporisable liquid being used.

The present invention is significantly distinguished from prior art devices in that the heater housing comprises a gap which both supports the heating element and is variable in size to alter the liquid flow rate through the gap to the heater. The fact that the heater housing is configured to provide the dual function of holding the heating element and adjusting liquid flow reduces the number of parts required and reduces the overall complexity of the device. In particular, since a gap is already provided to support the heating element, the inventors have realised that this can also be harnessed to provide a variable liquid flow to adapt to different liquid viscosities. Furthermore, with this arrangement the variable liquid flow is provided directly onto the heating element, since the gap also supports the heating element, allowing for an instant change in the amount of liquid being vaporised when the size of the gap is changed.

Preferably the heating element is supported within the gap in the heater housing to hold the heating element within the heater housing. For example, an end or edge of the heating element is held within the gap in the heater housing. Preferably the heater housing comprises two gaps positioned on opposing sides of the heater housing; wherein the heating element is held within the two gaps such that the heating element extends across the heater housing between the opposing sides. The thickness of the heating element is preferably equal or less than the size of the one or more gaps in the heater housing.

Preferably the heating element is supported within the gap so as to leave an open portion of the gap through which liquid can pass. In some examples the size of the gap may be reduced to close the open portion, wherein the heating element comprises a porous of fibrous material arranged to transport liquid through the heating element. In particular, in some examples, one or more portions of the gap are variable in size to adjust the liquid flow through the gap, whereas the remainder of the gap has a constant size. In some examples, portion of the gap which hold the heating element remain constant in size, whereas other, open portions of the gap are adjustable to change the liquid flow.

Preferably the heating element is held within the gap such that the size of the gap may be varied to adjust an open portion of the gap which allows liquid to travel around the heating element. In such embodiments, where the heating element is a capillary heating element, a portion of the liquid transport from the liquid store to the heating element for vaporisation is provided by capillary transport through the heating element and an additional portion is provided by liquid transport through the open portion of the gap. In this way, by varying the gap size, the ratio liquid transport through the capillary heating element and liquid transport through the open portion of the gap may be varied to change the flow rate of a liquid into the heater housing.

The heating element comprises a sheet of heating material; the heating element housing comprises a tubular heating housing and the gap is a longitudinal gap running along the length of the tubular heating element housing; wherein the heating element is arranged such that a peripheral edge of the heating element is supported within the gap. This provides a compact arrangement in which the size of the liquid store can be increased while providing reliable liquid transport into the heater housing for vaporisation.

Preferably the sheet of heating material is porous and/or fibrous in order to provide transport of the liquid through the heating element by capillary action. Preferably the heating element comprises a sheet of electrically conductive fibre mesh arranged to transport liquid by capillary action. The density of the mesh may be from about 10⁻⁶ to 10⁻² g/mm³, preferably in a range between 5x10⁻⁴ to 5x10⁻³ g/mm³, and more preferably approximately 8.5x10⁻⁴ g/mm³. Preferably the heating element comprises electrically conductive fibres which are arranged as a woven fabric, such as a mesh, a non-woven fabric, or a bundle of electrically conductive fibres. In this way the mesh provides a wicking function to the heating element such that an aerosol generating liquid can be effectively drawn onto the heating element for vaporisation.

Preferably the tubular heater housing comprises a first and second longitudinal portion, wherein the first and second heater housing portions meet at a longitudinal interface which defines the longitudinal gap and the heating element is held within the longitudinal interface such that the heating element extends along the length of the tubular heater housing. Preferably the heating element is attached to one of the first and/or second heater portions. This allows the heating element to be supported stably as the size of the gap between the first and second heater portions is varied.

Preferably the heating element is a resistive heating element comprising two contact points to which a power source may be connected to provide a current through the heating element to heat the heating element. The contact points may be positioned at opposite sides of the heating element such that the preferential path runs across the heating element from one side to another. Alternatively the contact points may be provided in the same side such that the preferential path travels out from one side across the heating element and turns to return to the same side.

Preferably the heating element comprises a sheet shaped so as to follow a serpentine path in the plane of the sheet, i.e. the sheet has a serpentine shape, in other words a meandering, zig-zag, periodic or square-wave shape. In this way the temperature distribution across the heating element can be controlled by varying the structure or shape of the heating element such that the current and/or heat flows along a meandering or square-wave pattern. In this way, as an electrical current travels along the sheet, different concentrations of current are provided in different regions. In use, areas of relatively high current density will become hotter than areas of relatively low current density, thus establishing a temperature gradient across the sheet which promotes enhanced liquid transport and vaporisation.

Preferably the heater housing is configured such that the size of the gap varies with temperature. In particular the heater housing may be configured such that the size of the gap is reduced at relatively higher temperature and increased and relatively lower temperatures. In this way, the increase in viscosity of the vaporisable liquid with increased temperature is compensated by reducing the size of the gap to maintain an optimal liquid flow rate.

Preferably at least a portion of the heater housing adjacent to the gap comprises a material which expands with increasing temperature such that the size of the gap decreases as the temperature of the portion of the heater housing increases. Preferably the portion of the heater housing expands under increasing temperature to reduce the size of the gap and limit the flow rate of vaporisable liquid through the gap.

Preferably the portion of the heater housing comprises a material with a coefficient of linear thermal expansion of at least 10, preferably at least 15, more preferably at least 20. In some embodiments the portion of the heater housing comprises a material with a coefficient of linear thermal expansion of at least 50. Preferably the portion of the heater housing comprises one or more of: steel, nickel, copper, brass, Kapton™, Aluminium, PVC, Polypropylene or rubber.

In some embodiments the heater housing comprises one or more of the above materials or material of the above coefficients of linear thermal expansion.

Preferably a portion of the heater housing adjacent to the gap comprises a shape memory alloy configured to change shape when exposed to increasing temperature to change the size of the gap in the heater housing. Preferably the portion of the heater housing adjacent the gap is configured to change shape under increasing temperature in order to reduce the size of the gap. Preferably portions of the heater housing on either side of the gap are configured to extend or bend towards each other under increasing temperature to reduce the size of the gap and limit the rate of liquid flow through the gap. Preferably at least a portion of the heater housing comprises one or more of: copper-aluminium-nickel, nickel-titanium (NiTi), an alloy of zinc, copper, gold and/or iron, Fe—Mn—Si, Cu—Zn—Al and Cu—Al—Ni.

Preferably wherein the heater housing further comprises a gasket configured to mechanically vary the size of the gap. Preferably the gasket comprises a mechanical mechanism for varying the size of the gap. Preferably the gasket comprises two moveable parts and the gap is defined between the movable parts wherein the gasket is configured to move the movable parts away from each other or towards each other to change the size of the gap. Preferably the heater housing comprises two housing parts wherein the gap is provided at an interface between the two housing parts and the mechanical mechanism is configured to vary the separation between the two housing parts to change the size of the gap.

Preferably the heater housing further comprises a sensing element wherein the gasket is configured to change the size of the gap according to a sensed parameter of the heating element. In this way, the size of the gap can be adjusted in response to the changing parameters of the heating element or liquid store, for example to automatically adjust the size of the gap. In this way a feedback loop can be implemented to automatically compensate for changing parameters such as temperature or type of vaporisable liquid.

Preferably the sensing element is configured to sense one or more of: the temperature of a liquid in the liquid store; the temperature of the heating element; information provided in a machine-readable ID.

Preferably the size of the gap is variable across a range of at least 0.2 mm to 0.3 mm, preferably 0.1 mm to 0.3 mm. Preferably the size of the gap may be varied between 0 and 0.3 mm, preferably between 0.15 and 0.3 mm. When the heating element is held within the gap, the above sizes correspond to the distance across the gap (i.e. including the thickness of the heating element). For example where the gap is a gap between portions of the heater housing the above size of the gap is measured across the gap between the portions of the heater housing. Preferably the heating element has a thickness of 0.1 mm to 0.2 mm, preferably around 0.1 mm. Therefore preferably the size of the open portion of the gap (the size of the gap minus the thickness of the heating element) is variable between 0 and 0.1 mm or between 0.05 and 0.15 mm, preferably between 0 and 0.2 mm. Preferably the heating element is a capillary heating element. In this way the proportion of liquid transport through the capillary heating element and the proportion of liquid flow around the heating element through the open portion of the gap can be varied to adjust the rate of liquid flow and optimise vaporisation.

Preferably the vaporiser further comprises a vaporisable liquid held within the liquid store, the vaporisable liquid comprising vegetable glycerine, VG, and, propylene glycol, PG, wherein: the size of the gap is variable to a value in the range 0.05 to 0.25 mm and the ratio of VG:PG is 30:70; or the size of the gap is variable to a value in the range 0.15 to 0.35 mm and the ratio of VG:PG is 50:50; or the size of the gap is variable to a value in the range 0.20 to 0.45 mm and the ratio of VG:PG is 70:30. Since the viscosity of a vaporisable liquid is heavily dependent on the ratio of VG:PG, in this way, the size of the gap in the housing can be varied to compensate for both the viscosity of the vaporisable liquid and the effects of temperature on the viscosity such that optimum liquid flow and accordingly vaporisation can be maintained.

In a further aspect of the invention there is provided an aerosol generating device comprising: the vaporiser of any preceding claim; and a power source arranged to provide current to the heating element of the vaporiser. Preferably the aerosol generating device comprises an electronic cigarette. Preferably the electronic cigarette further comprises a cartridge seating configured to receive a removable cartridge; and a removable cartridge wherein the vaporiser is provided within the removable cartridge.

In a further aspect of the invention there is provided a cartridge for an aerosol generating device, the cartridge comprising the vaporiser of any of claims

In a further aspect of the invention there is provided a vaporiser for an aerosol generating device comprising: a heating element; a heater housing arranged to hold the heating element within the heater housing; and a liquid store holding a vaporisable liquid; wherein the heater housing comprises a gap arranged to allow the vaporisable liquid pass from the liquid store into the heater housing to be vaporised by the heating element during use; wherein the vaporisable liquid comprises vegetable glycerine, VG, and, propylene glycol, PG, wherein the size of the gap is selected based on the ratio of VG: PG as follows:

| | | |
|---|---|---|
| Ratio of VG:PG between | Size of the gap | Preferable size of gap |
| 20:80 and 40:60 | 0.05 to 0.15 mm | 0.1 mm |
| 40:60 and 65:35 | 0.15 to 0.25 mm | 0.2 mm |
| 65:35 and 80:20 | 0.25 to 0.4 mm | 0.3 mm |

Since the viscosity of the vaporisable liquid changes based on the ratio of VG:PG, the rate of flow from the liquid store to the heating element changes depending on the type of vaporisable liquid being used. By selecting the size of the gap as defined above based on the ratio of VG:PG in the liquid, a flow rate stays within required limits to provide optimised vaporisation. In particular, a size of gap in this range will ensure a steady supply of liquid to the heating element while preventing “flooding” of the heating element which can restrict vapour generation.

The above gap size ranges apply whether the gap is fully open to allow liquid flow through the gap or whether a capillary or porous material is placed within the gap. In the latter case, the flow rate is reduced slightly but not sufficiently for the above gap size ranges to change.

Preferably the heating element is supported within the gap in the heater housing to hold the heating element within the heater housing. For example, an end or edge of the heating element is held within the gap in the heater housing. Preferably the heater housing comprises two gaps positioned on opposing sides of the heater housing; wherein the heating element is held within the two gaps such that the heating element extends across the heater housing between the opposing sides. The thickness of the heating element is preferably equal or less than the size of the one or more gaps in the heater housing.

Preferably the heating element comprises a sheet of heating material; the heating element housing comprises a tubular heating housing and the gap is a longitudinal gap running along the length of the tubular heating element housing; wherein the heating element is arranged such that a peripheral ede of the heating element is supported within the gap. The size of the gap may be measured across the gap, perpendicular to the longitudinal direction. This provides a compact arrangement in which the size of the liquid store can be increased while providing reliable liquid transport into the heater housing for vaporisation.

Preferably the heating element is a capillary heating element configured to transport liquid via capillary action through the heating element. Preferably the heating element is held within the gap in the heater housing. In this way, the gap sizes defined above apply since liquid can be transported both through the heating element and around the heating element through an open portion of the gap.

Preferably the heating element is a sheet of electrically conductive fibre mesh, preferably a sintered mesh of stainless steel fibres. Such a heating element provides good liquid transport through the heating element and as such may be combined with a gap size as defined above to provide optimised liquid transport with the selected vaporisable liquid.

Preferably the heating element is a capillary heating element arranged to transport liquid through the heating element and the thickness of the capillary heating element is between 0.1 and 0.2 mm. Preferably the heating element is held within the gap such that an open portion of the gap is defined as the total distance across the gap minus the thickness of the heating element. In these embodiments, the open portion of the gap may be selected as follows:

| | |
|---|---|
| Ratio of VG:PG between | Size of open portion of the gap |
| 20:80 and 40:60 | 0.00 to 0.05 mm |
| 40:60 and 65:35 | 0.05 to 0.15 mm |
| 65:35 and 80:20 | 0.15 to 0.25 mm |

In this way, the vaporisable liquid can pass both through the capillary heating element and through the open portion of the gap to provide a flow rate optimised for the viscosity of the type of vaporisable liquid used. Vaporisers with the heating element, liquid and heater housing configured in this way have been shown to provide reliable vaporisation of the selection of vaporisable liquid.

The vaporiser of this aspect of the invention may further be configured as described above under the first aspect of the invention.

### BRIEF DESCRIPTION OF THE DRAWINGS

Embodiments of the invention are now described, by way of example, with reference to the drawings, in which:

FIG. 1 is a schematic view of a vaporiser according to the present invention;

FIGS. 2A and 2B are schematic cross-sectional views of a vaporiser according to the present invention;

FIGS. 3A and 3B are schematic cross-sectional views of a vaporiser according to the present invention;

FIGS. 4A and 4B are schematic cross-sectional views of a vaporiser according to the present invention;

FIG. 5A schematically illustrates an alternative heating element for use with the vaporiser of the present invention;

FIG. 5B illustrates the heating element of FIG. 5A held in a tubular heater housing for use in a vaporiser according to the present invention.

### DETAILED DESCRIPTION

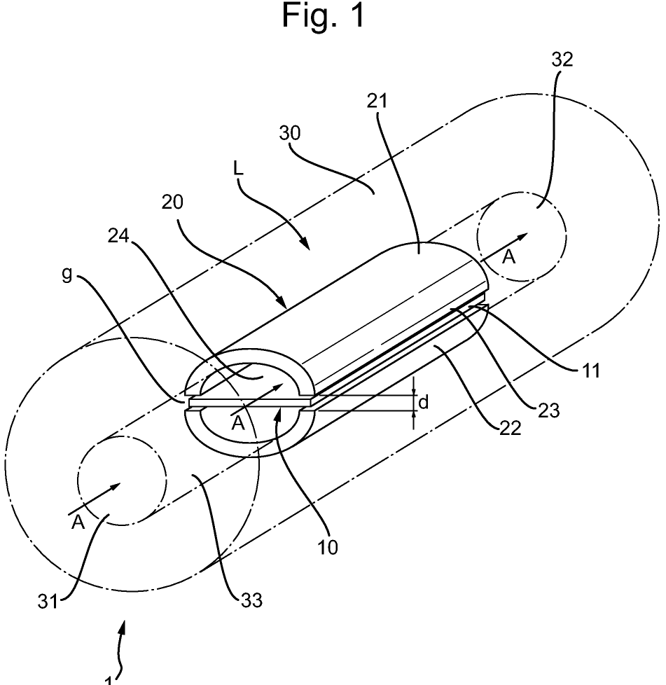

FIG. 1 schematically illustrates a vaporiser 1 for an aerosol generating device according to the present invention. The vaporiser 1 includes a heating element 10, a heater housing 20 which is arranged to hold the heating element 10 within the heater housing 20 and a liquid store 30. The heater housing 20 includes a gap g arranged to allow a liquid to pass from the liquid store 30 into the heater housing 20 to be vaporised by the heating element 10 during use. The size of the gap g is variable to change the rate of liquid flow through the gap g. In this way, the rate of liquid flow from the liquid store 30 into the heater housing 20 can be altered in order to ensure that an optimum flow rate of liquid L reaches the heating element 10 for vaporisation, thus ensuring that the heating element does not overheat due to a lack of liquid L reaching the heating element 10, nor does it become flooded if too much liquid L reaches the heating element. This provides improved reliability and reproducibility in aerosol generation and therefore increased performance, particularly when employed in an aerosol generating device such as an electronic cigarette.

In the example of FIG. 1 the heating element 10 comprises a sheet of heating material which is held substantially within a tubular heating housing 20. In particular the tubular heater housing comprises two parts 21, 22 which meet at a longitudinal interface 3 which defines the gap g in the heater housing 20. The heating element 10 extends along the length of the tubular heating housing 20 and is held within the longitudinal interface 23 between the first and second heater housing parts 21, 22. In other words, the peripheral longitudinal edges 11 of the heating element 10 are supported within the longitudinal gap g and the heating element 10 is thereby supported within the tubular heating housing 20 and runs longitudinally along its length.

As shown in FIG. 1 the heater housing 20 is surrounded by the liquid store 30. In this way, the liquid L surrounds the heater housing 20 and is transported from the liquid store 30 into the internal volume of the heater housing through the gap g at the longitudinal interface 23 between the first and second housing parts 21, 22. The liquid store 30 further defines a longitudinal vapour flow passage 33 which runs between an air inlet 31 on one side of the liquid store 30 and a vapour flow outlet 32 on the opposing side of the liquid store 30. The vapour flow passage way 33 runs from the inlet 31 through the internal volume 24 (or 20 and out of the outlet 32. When the vaporiser 1 is employed in an aerosol generating device the heating element 10 is connected to a power source such that a current can be provided through the heating element to increase the temperature via resistive heating. In this way, liquid L in the heater housing is vaporised, driving further liquid transport through the gap g via capillary action and further vapour generation.

The air inlet 31 is connected to an air inlet in the body of the aerosol generating device and the vapour flow outlet 32 is connected to a mouthpiece outlet. In this way, by providing power to the heater whilst inhaling at the mouthpiece, air enters the air inlet 31 and passes through the heater housing 20, picks up the vapour generated in the internal volume 24 of the heater housing and is drawn through the outlet 32 for inhalation, as shown by the air flow arrows A in FIG. 1.

In the examples shown in the figures the heating element is provided by a sheet of electrically conductive fibre mesh. The fibres of the heating element may be made of a metal, such as stainless steel, non-stainless steel, iron, copper, tungsten, aluminium, brass, Nichrome, Kanthal, Cupronickel and other alloys, or any other metal (element, compound or alloy). Alternatively, the fibres may be made of a non-metal material such as molybdenum disilicide, silicon carbide and other ceramics or semiconductors, or any other non-metal. In particularly preferably examples the heating element comprises a sintered mesh of stainless steel fibres.

Porous heating elements of this type are able to transport liquid through their porous structure by capillary action such that liquid transport through the gap g may take place both through the heating element 10 held in the gap and around the heating element if there is additional open space within the gap.

The rate of liquid flow from the liquid store 30 into the heater housing 20 through the gap g is an important parameter in optimising vapour generation. Carefully selecting the liquid flow rate is necessary to provide the correct rate of delivery of liquid to the heater. In particular, two low a flow rate and two little liquid reaches the internal volume 24 of the heater housing 20 which can cause the heater 10 to overheat causing potential burning of the heater and inhalation of associated dry heated air from the heater chamber without vapour (the “dry vape” effect). If the flow rate is too high the internal volume 24 of the heater housing 20 can become flooded which can block vapour generation and reduce the temperature of the heating element. It can also result in large droplets of liquid being extracted on the vapour flow path A into the mouth of a user. It is therefore important to carefully control the liquid flow rate through the gap g into the internal volume 24 of the heater housing 20.

The rate of liquid flow into the heater housing 20 is dependent on the size d of the gap g between the liquid store 30 and the internal volume 24 of the heater housing 20 and the viscosity of the liquid L. The rate of liquid flow through a particular gap size d can therefore differ depending on the particular variety of vaporisable liquid L contained in the liquid store 20. Many conventional vaporisable liquids for electronic cigarettes include a mixture of vegetable glycerine, VG, and, propylene glycol, PG. The ratio of these two components is of particular significance in determining the viscosity of the liquid and therefore the liquid flow rate through the gap.

It has been determined that the size of the gap g can be selected based on the ratio of VG to PG in order to provide an optimum flow rate. In particular, it has been determined that the size d across the gap g, as shown in FIG. 1, should be in the range 0.05 to 0.15 mm when the ratio of VG to PG is approximately 20 to 80; the size of the gap d should be in the range 0.15 to 0.25 mm when the ratio of VG to PG is 60 to 40; and the size d of the gap g should be in the range 0.25 to 0.35 mm when the ratio of VG to PG is 20 to 80. These figures correspond to both arrangements in which the gap is fully open or when a capillary heating element is held in the gap as the latter provides for liquid transport through the capillary heating element.

Further descriptive data on the type of flow observed for different gap sizes and VG:PG liquid ratios is provided in the tables below.

VG:PG 70:30

| Gap size (mm) | Liquid Column (ml) | Flow |
|---|---|---|
| 0.01 | 2 | No |
| 0.06 | 2 | No |
| 0.11 | 2 | No |
| 0.15 | 2 | In Gap - Slow |
| 0.18 | 2 | In Gap - Slow/no drops on other side |
| 0.26 | 2 | In Gap - Slow/no drops on other side |
| 0.3 | 2 | Drop forming |
| 0.35 | 2 | Drop beading |
| 0.5 | 2 | Flow |

| | VG:PG 30:70 | |
|---|---|---|
| Gap size (mm) | Liquid Column (ml) | Flow |
| 0.05 | 2 | No flow |
| 0.1 | 2 | in Gap |
| 0.15 | 2 | In gap |
| 0.18 | 2 | Flow |
| 0.25 | 2 | Flow |
| 0.4 | 2 | High flow |

| | VG:PG 50:50 | |
|---|---|---|
| Gap size (mm) | Liquid Column (ml) | Flow |
| <0.15 | 2 | no flow |
| 0.18 | 2 | Starting to bead |
| 0.25 | 2 | Drop forming |
| 0.4 | 2 | flowing |

For effective vaporisation to occur it is important to avoid having the gap too small such that there is no flow through the gap and also to avoid having the gap too large such that liquid is flowing through the gap. Preferably the gap size should be selected such that liquid is present in the gap and a droplet is forming or beading on the other side of the gap.

These values are given for temperatures of the normal working range of an aerosol generating device such as an electronic cigarette. In the device according to the present invention, the size of the gap d may further be varied to provide selection of the flow rate to suit different liquids and operating temperatures. In particular, by varying the gap size d shown in FIG. 1 the liquid flow rate can be changed during use of the device to compensate for different liquid viscosities or changes in viscosity due to temperature. This variation in gap size can be achieved in a number of different ways.

In certain embodiments of the present invention, the heater housing may be configured such that the size of the gap g varies with temperature. In particular, the heater housing 20 preferably comprises a material which expands under increasing temperature to reduce the size of the gap g and therefore compensate for the increase viscosity of the liquid L at higher temperatures by reducing the size of the gap g to restrict the liquid flow from the liquid store into the internal volume 24 of the heater housing 20.

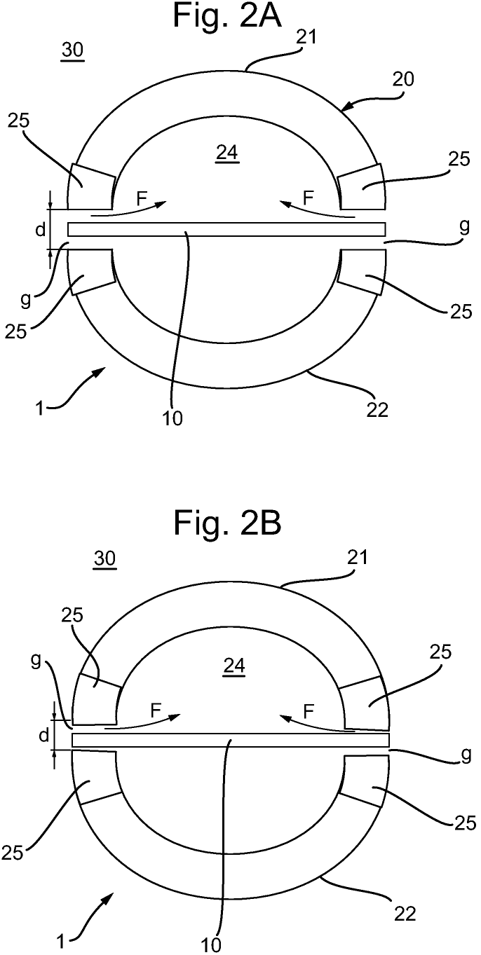

In the example of FIG. 2A and FIG. 2B, portions 25 of the heater housing 20 comprise a material with an increased coefficient of thermal expansion such that these portions 25 expand to reduce the size of the gap g. In particular, the portions 25 of the heater housing 20 which are adjacent to the gap comprise a material with increased coefficient of thermal expansion such that these portions 25 expand towards the heating element 10 closing the gap to reduce the liquid flow F through the gap G. As shown in FIG. 2A, at a first lower temperature, the size of the gap g between the upper 21 and lower 22 housing portions is a first value which permits an increased flow F of liquid from the surrounding liquid store through the gap g into the internal volume of the heater housing 20. As the temperature increases, the portions 25 of the heater housing 20 neighbouring the gap g expand such that the size d of the gap g is reduced to a lower value thus limiting the flow of liquid to a new reduced flow rate F. In this way, although the viscosity of the liquid L is increased at the higher temperatures shown in FIG. 2B, because the portions 25 of the heater housing 20 expand, the size of the gap d is reduced thus keeping the liquid flow F substantially constant such that the vapour generation does not substantially change during changes in temperature.

The portions 25 of the heater housing with an increased coefficient of thermal expansion may be made of any appropriate material which significantly expands or increases in temperature, whilst providing the required mechanical strength and robustness for the heater element housing 20. For example, the portions 25 of the heater housing 20 may be polypropylene, PVC, aluminium, Kapton™, brass, copper or nickel. Although in the embodiment of FIGS. 2A and 2B it is only regions of the heater housing 20 which are adjacent to the longitudinal gap g which are made of the material of increased thermal expansion, in other embodiments a larger proportion or the entirety of the heater housing 20 may be constructed from a material with increased thermal expansion such that larger portions of the entirety of the heater housing 20 expands to restrict the gap g between the heater housing components and accordingly adjust a flow rate F into the internal volume 24 of the heater housing 20.

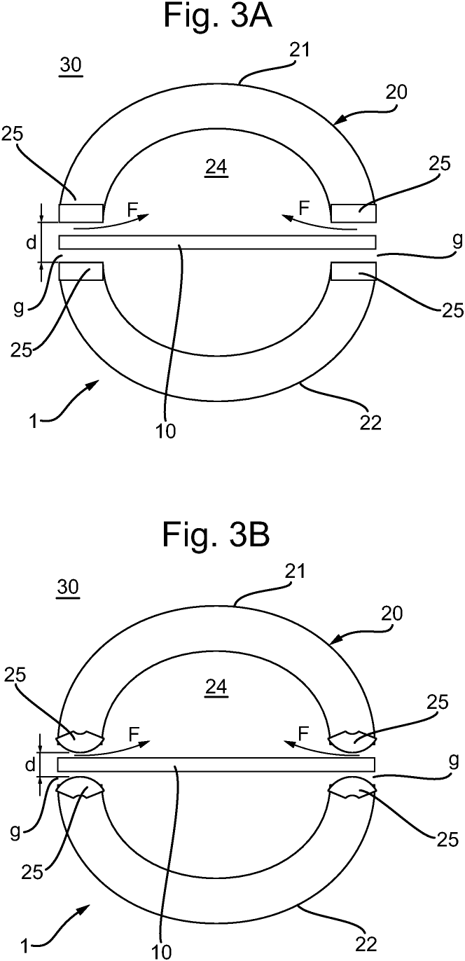

The example of a vaporiser 1 according to the present invention illustrated in FIGS. 3A and 3B is similar to that shown in FIG. 2 except in the case of FIG. 3, the portions of the heater housing 20 comprises a shape memory alloy rather than simply a material with a high coefficient of thermal expansion. Shape memory alloys are alloys that return to a particular shape when heated. In this way, an increase in ambient temperature can be used to return the portions 25 of the heater housing 20 neighbouring the gap g to a pre-remembered shape in order to restrict the size of the gap g at elevated temperatures. As shown in FIG. 3A, at a lower temperature the portion 25 of the heater housing 20 which bounds the gap g has a first shape which provides an increased size d of the gap g to allow a certain liquid flow rate F through the gap g for vaporisation by the heating element 10 within internal volume 24 of the heater housing 20. As the temperature of a heater housing 20 increases, as shown in FIG. 3B, the shape of the portions 25 of the heater housing 20 bounding the gap g changes so that the portions extend towards each other restricting the size d of the gap g and accordingly restricting the liquid flow into the housing. In this way, the flow rate F of the liquid from the liquid store 30 into the heater housing 20 can be maintained even as the viscosity of the liquid increases at higher temperatures as the size of the gap is restricted by the change in shape of the portions 25 of the heater housing 20 to compensate such an optimum flow rate F can be maintained.

Examples of suitable materials from which the bounding portions 25 around the gap g can be constructed include copper-aluminium-nickel, nickel-titanium (NiTi), an alloy of zinc, copper, gold and/or iron, Fe—Mn—Si, Cu—Zn—Al and Cu—Al—Ni. Again, although in the example of FIGS. 3A and 3B it is only portions 25 of the heater housing 20 neighbouring the gap g which are constructed of a shape memory alloy, in other examples larger portions or the entirety of the heater housing may be constructed from a shape memory alloy such that a change in shape of the significant portion on the entirety of the heater housing can act to reduce the size of the gap g and restrict the flow of liquid at increased temperatures into the heater housing 20 for vaporisation.

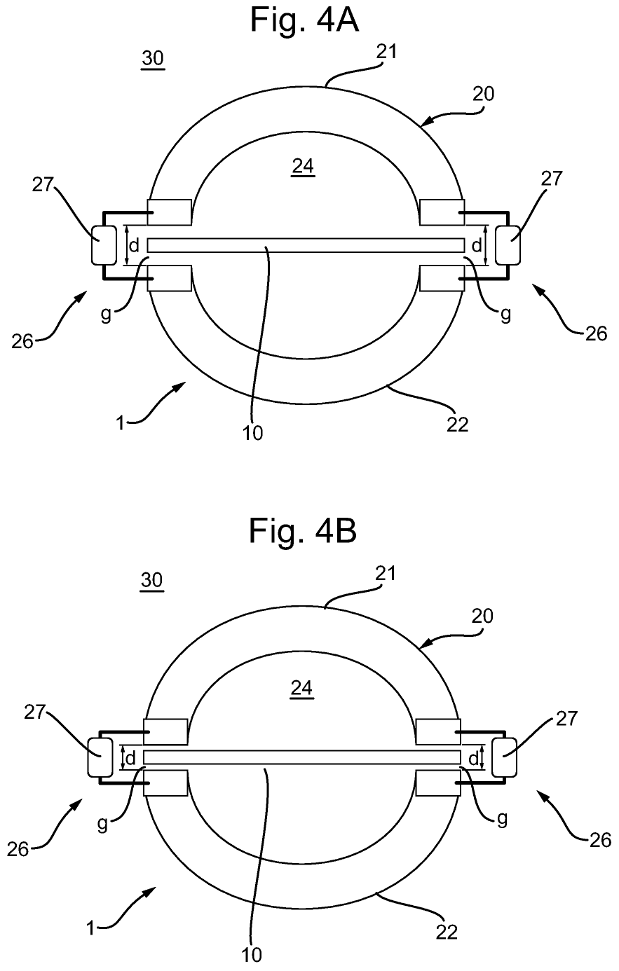

In the examples of FIG. 2 and FIG. 3, the heater housing 20 is configured to change the size of the gap under a change in temperature by using appropriate materials which automatically restrict the size of the gap at increased temperatures to compensate for the increased viscosity at the liquid. In other examples, a control mechanism may be inserted into the device for mechanically altering the size of the longitudinal gap g along the tubular heater housing 20 to mechanically adjust the size of the gap g to alter a flow rate. In this way, rather than simply adjusting the size of the gap g for changes in temperature, the flow rate may be adjusted independently of temperature, for example to change the volume of vapour produced to suit user preferences or to adjust the size of the gap for a particular viscosity of liquid included in the liquid store 30. The example of FIG. 4A and FIG. 4B comprises a mechanical gasket configured to vary the size of the gap g between the first and second housing components 21, 22. In particular, the vaporiser 1 comprises a mechanical component 27 which can change the displacement between the first, upper housing portion 21 and the second, lower housing portion 22 to adjust the size of the gap g.

The mechanical gasket 26 may comprise a linear actuator 27 with one end connected to the upper housing portion 21 and a second end connected to the lower housing portion 22. The linear actuator 27 may be configured to move the housing portions apart or together as directed by control circuitry provided within the vaporiser or the constituent aerosol generating device. The mechanical actuator 27 may comprise any suitable mechanical components for providing an increased linear displacement between the upper 21, and lower 22 housing components. In particular, the linear actuator 27 may be provided by a screw such as a lead screw or ball screw configured to increase or decrease the distance d between the upper housing component 21 and the lower housing component 22.

The vaporiser 1 may additionally comprise a user control for providing control signals to the mechanical gasket in order to allow a user to select a particular gap size and accordingly a flow rate of liquid into the heater housing 20. For example, a user may adjust the mechanical gasket using a user interface provided on the electronic cigarette or on a corresponding user device for example on an app supported on a smartphone or other user device to select the size of gap to provide a flow rate to provide a specific degree of vapour generation to suit a user’s preferences or to select it according to the viscosity of a liquid in a particular cartridge or consumable used.

In other examples of the device, the vaporiser may additionally comprise a sensing element connected to the mechanical gasket such that the mechanical gasket is configured to change the size of the gap g according to a sensed parameter of the heating element. For example, a feedback loop may be implemented whereby a sensing element senses a particular parameter associated with the vaporiser and accordingly instructs the mechanical gasket such as the linear actuator 27 may to adjust the size of the gap accordingly.

For example, a temperature sensor may be provided in the vaporiser to sense the temperature of a liquid in a liquid store, the temperature of the heating element or a temperature in the internal volume 24 of the heater housing 20. Alternatively, the sensing element may be a reader configured to read a machine readable ID in order to extract information and control the gasket to alter the distance d of the gap g accordingly. For example, a consumable may comprise a machine readable ID which is read by a sensor connected to the vaporiser in order to extract information regarding the viscosity of a liquid within the consumable. Control circuitry within the vaporiser of the aerosol generating device including the vaporiser, may then use this data extracted from the machine readable ID in order to control the mechanism 27 and adjust the size d of the gap g to provide an optimum gap size and accordingly a flow rate for the specific viscosity of liquid provided in the consumable.

Although not shown in the figures, in all embodiments the heating element 10 may be attached to one of the portions of the heater housing, for example the upper or lower housing portions such that it remains supported by the heater housing as the size d of the gap g between the housing components is adjusted.

In the examples of the present invention, the planar sheet of heating material has a thickness between approximately 0.1 and 0.2 mm preferably around 0.15 mm. The size of the gap, as provided by the distance d between the upper housing portion 21 and lower housing portion 22 is preferably variable across a range of at least 0.2 mm to 0.3 mm, preferably 0.1 mm to 0.35 mm. Since the heating element 10 has a thickness of approximately 0.1 to 0.2 mm, the size of the open portion of the gap through which liquid can pass may vary between 0 and 0.15 mm.

Preferably the heating element is provided by a capillary heating sheet configured to provide liquid transport through the heating element 10. In particular, the heating element 10 may comprise a porous material such that liquid transport may take place through the interstices of the heating element. In particularly preferable embodiments of the invention the heating element 10 comprises a sheet of electrically conductive fibre mesh, in particular a sintered mesh of stainless steel fibres. Such heating elements are able to provide both resistive heating and capillary transport of liquid through the heating element to provide liquid transport for vaporisation.

With embodiments according to the present invention, the size of a gap g defining the liquid flow route from a liquid store through a heater housing 20 to the heating element 10 may be varied to adjust the rate of liquid flow to change the parameters of vaporisation. In particular, the size d of the gap g may be adjusted to compensate for the viscosity of the liquid such that an optimum liquid flow rate may be maintained despite changing temperatures or differing vaporisable liquids being used to ensure that a required volume of liquid reaches the heat of vaporisation and the vaporiser delivers consistent performance to a user.

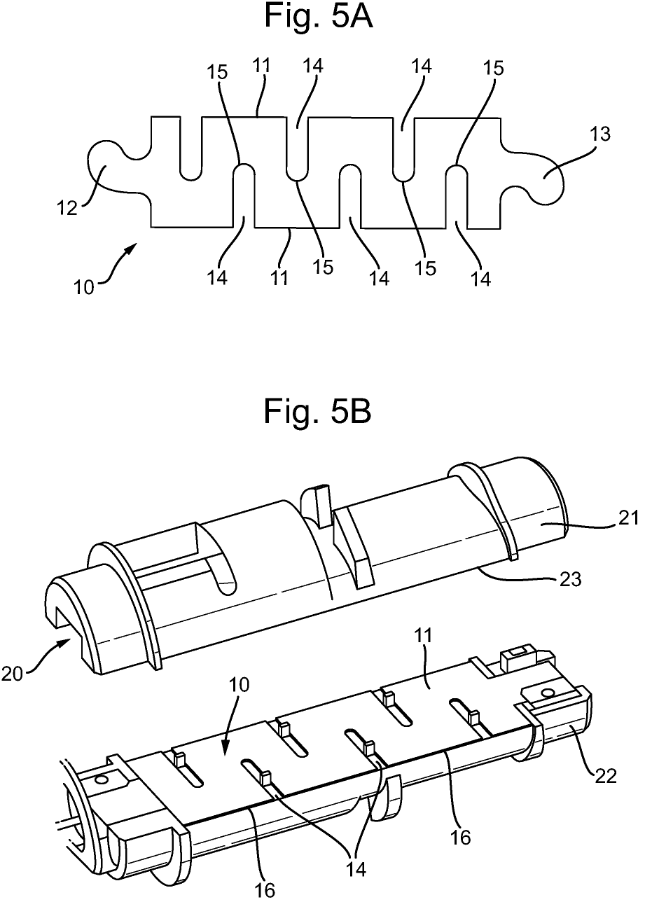

In some embodiments of the invention the sheet can have a periodic shape such as a square wave shape in the plane of the heating element such as that shown in FIG. 5A. In particular the planar heating element has a number of slots 14 extending inwardly from the longitudinal edges 11.

As with each of the heating elements 10 described above, the planar heating element extends in lengthwise direction between a first 12 and second 13 end. Contacts are provided on the first and second ends 12, 13 for connection to a power source such that a current can travel along the length of the heating element between the first and second ends 12, 13. Because, of the serpentine or “square-wave” shape, the current is forced into following a periodic serpentine path through the heating element from the first 12 to the second end. This type of periodic shape therefore leads to regions of increased current density particularly at the inner corners 15. This distribution of varying current density across the sheet of heating material causes the formation of temperature gradients across the heating element, in particular from the peripheral edges 11 increasing to the inner corners 15. This improves the capillary performance of the heating element in transporting liquid from the peripheral edges in communication with the liquid supply to the central regions of the heater which are heated to elevated temperatures.

As with the embodiments of FIGS. 1 to 4, the heating element of FIG. 5A may be held within a tubular heater housing 20 as shown in FIG. 5B. In particular, the heating element 10 is held between an upper heater housing portion 21 and a lower heater housing portion 22, wherein the edges 11 of the heating element 10 are held between the heater housing portions within a longitudinal interface 23 between the two portions 21, 22. A gap g is provided at the interface 23 and the size of the gap is variable to adjust the rate of flow of a liquid from a liquid store surrounding the heater housing 20 through the gap g into the internal volume of the heater housing for vaporisation. The gap may be adjustable by any of the means described above.

In the case of this periodic shaped heating sheet 10 of FIG. 5, a series of additional gaps are provided along the longitudinal interface 23 corresponding to the positions of the slots 14 along the edge 11 of the heating element. These gaps are not filled with the thickness of the heating element 10, unlike positions 16 along the interface 23 in which the edge 11 of the heating element is held. In some embodiments these gaps are left free and provide an additional flow route of liquid from the liquid store 30 into the heater housing 20. In other embodiments they may be blocked to restrict the liquid flow or filled with a material with the same thickness as the heating element such that liquid flow through the gap g is uniform along the longitudinal interface. In either case, the advantages of the present invention may still be achieved by providing a variable gap size to adjust the rate of liquid flow through the gap in order to provide reliable and constant vapour generation characteristics.

The vaporisers shown in FIGS. 1 to 5 may be incorporated into an aerosol generating device such as an electronic cigarette. In particular the heating element 10 may be connected to a power supply via contacts positioned at either longitudinal end of the heating element 10 such that a current may be passed along the length of the heating element. The vaporiser 1 may be connected such that an air inlet in the vaporisation device connects to the air inlet 31 of the vaporiser 1, shown in FIG. 1, and the vapour outlet 32 may be connected to the vapour flow passage through a mouthpiece of a device. The vaporiser 1 may be provided as an integral part of the electronic cigarette wherein the liquid in the liquid store 30 may be refilled by a user or a separate consumable positioned in the device and connected to the liquid store 20. Alternatively the vaporiser 1 itself may be provided as a removable cartridge to be received in an aerosol generating device, in the form of a “cartomiser”.

1. A vaporiser for an aerosol generating device, the vaporiser comprising:
a heating element comprising a sheet of heating material;
a tubular heater housing arranged to hold the heating element within the heater housing; and a liquid store;
wherein the heater housing comprises a longitudinal gap running along the length of the tubular heater housing and the heating element is arranged such that a peripheral edge of the heating element is supported within the gap;
wherein the gap is arranged to allow a liquid to pass from the liquid store into the heater housing to be vaporised by the heating element during use; and
wherein a size of the gap is variable so as to change the rate of liquid flow through the gap.

2. The vaporiser of claim 1 wherein the sheet of heating material comprises a sheet of electrically conductive fibre mesh arranged to transport liquid by capillary action.

3. The vaporiser of claim 1 wherein the heater housing is configured such that the size of the gap varies with temperature.

4. The vaporiser of claim 3 wherein a portion of the heater housing adjacent to the gap comprises a material which expands with increasing temperature such that the size of the gap decreases as the temperature of the portion of the heater housing increases.

5. The vaporiser of claim 3 wherein a portion of the heater housing adjacent to the gap comprises a shape memory alloy configured to change shape when exposed to increasing temperature, so as to change the size of the gap in the heater housing.

6. The vaporiser of claim 1 wherein the heater housing further comprises a gasket configured to mechanically vary the size of the gap.

7. The vaporiser of claim 6 further comprising a user control for operating the gasket to allow a user to change the size of the gap in the heater housing.

8. The vaporiser of claim 6 further comprising a sensing element wherein the gasket is configured to change the size of the gap according to a sensed parameter of the heating element or the liquid store.

9. The vaporiser of claim 8 wherein the sensing element is configured to sense one or more of:
the temperature of a liquid in the liquid store;
the temperature of the heating element; and
information provided in a machine-readable ID.

10. The vaporiser of claim 1 wherein the size of the gap is variable across a range of at least 0.2 mm to 0.3 mm.

11. The vaporiser of claim 1 further comprising a vaporisable liquid held within the liquid store, the vaporisable liquid comprising vegetable glycerine (VG) and propylene glycol (PG), wherein:
the size of the gap is variable to a value in a range of 0.05 to 0.25 mm and the ratio of VG:PG is 30:70; or
the size of the gap is variable to a value in a range of 0.15 to 0.35 mm and the ratio of VG:PG is 50:50; or
the size of the gap is variable to a value in a range of 0.2 to 0.45 mm and the ratio of VG:PG is 70:30.

12. An aerosol generating device comprising:
the vaporiser of claim 1; and
a power source arranged to provide current to the heating element of the vaporiser.

13. The aerosol generating device of claim 12 further comprising:
a cartridge seating configured to receive a removable cartridge; and
a removable cartridge wherein the vaporiser is provided within the removable cartridge.

14. A cartridge for an aerosol generating device, the cartridge comprising the vaporiser of claim 1.

15. The vaporiser of claim 1 wherein the size of the gap is variable across a range of at least 0.1 mm to 0.3 mm.
